(19) United States
(12) Patent Application Publication
(10) Pub. No.: US 2014/0357259 A1
(43) Pub. Date: Dec. 4, 2014

(54) Cell Outage Management

(71) Applicants: Dariusz Tomeczko, Wroclaw (PL); Sebastian Lasek, Duszniki Zdroj (PL); Maciej Pakulski, Czernica (PL)

(72) Inventors: Dariusz Tomeczko, Wroclaw (PL); Sebastian Lasek, Duszniki Zdroj (PL); Maciej Pakulski, Czernica (PL)

(73) Assignee: Nokia Solutions and Networks Oy, Espoo (FI)

(21) Appl. No.: 14/370,533

(22) PCT Filed: Jan. 5, 2012
(86) PCT No.: PCT/EP12/50142

§ 371 Date: Jul. 3, 2014

(51) Int. Cl. H04W 24/04; H04W 72/04

(52) U.S. Cl. CPC H04W 24/04; H04W 72/04
USPC 455/423

(57) ABSTRACT

The invention relates to an apparatus comprising: at least one processor and at least one memory including a computer program code, the at least one memory and the computer program code configured to, with the at least one processor, cause the apparatus at least to: obtain information on a need for at least partial compensation of a radio cell outage, and reconfigure a decreased channel bandwidth for at least temporal usage.

### FIELD

The invention relates to apparatuses, methods, systems, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Recently need for more efficient usage of radio resources has brought out an idea of self-organizing networks. Typically, as self-organizing networks are considered networks capable to carry out self-configuring and self-healing.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: detect a radio cell outage, and select at least one radio cell for at least partial compensation of the radio cell outage.

According to an aspect of the present invention, there is provided an apparatus comprising: at least one processor and at least one memory including a computer program code, the at least one memory and the computer program code configured to, with the at least one processor, cause the apparatus at least to: obtain information on a need for at least partial compensation of a radio cell outage, and reconfigure a decreased channel bandwidth for at least temporal usage.

According to yet another aspect of the present invention, there is provided a method comprising: detecting a radio cell outage, and selecting at least one radio cell for at least partial compensation of the radio cell outage.

According to yet another aspect of the present invention, there is provided a method comprising: obtain information on a need for at least partial compensation of a radio cell outage, and reconfigure a decreased channel bandwidth for at least temporal usage.

According to yet another aspect of the present invention, there is provided an apparatus comprising: means for detecting a radio cell outage, and means for selecting at least one radio cell for at least partial compensation of the radio cell outage.

According to yet another aspect of the present invention, there is provided an apparatus comprising: means for obtaining information on a need for at least partial compensation of a radio cell outage, and means for reconfiguring a decreased channel bandwidth for at least temporal usage.

According to yet another aspect of the present invention, there is provided a computer program embodied on a computer-readable storage medium, the computer program comprising program code for controlling a process to execute a process, the process comprising: detecting a radio cell outage, and selecting at least one radio cell for at least partial compensation of the radio cell outage.

According to yet another aspect of the present invention, there is provided a computer program embodied on a computer-readable storage medium, the computer program comprising program code for controlling a process to execute a process, the process comprising: obtaining information on a need for at least partial compensation of a radio cell outage, and reconfiguring a decreased channel bandwidth for at least temporal usage.

### LIST OF DRAWINGS

Some embodiments of the present invention are described below, by way of example only, with reference to the accompanying drawings, in which

FIG. 1 illustrates examples of systems;

FIG. 2 is a flow chart,

FIG. 3 is another flow chart;

FIG. 4 illustrates examples of apparatuses, and

FIG. 5 illustrates other examples of apparatuses.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution (LTE), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution advanced (LTE-A,), global system for mobile communication (GSM), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, and mobile ad-hoc networks (MANETs).

In an orthogonal frequency division multiplexing (OFDM) system, the available spectrum is divided into multiple orthogonal sub-carriers. In OFDM systems, the available bandwidth is divided into narrower sub-carriers and data is transmitted in parallel streams. Each OFDM symbol is a combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule downlink transmissions to user devices. Such required information is usually signalled to the (e)NodeB by using uplink signalling.

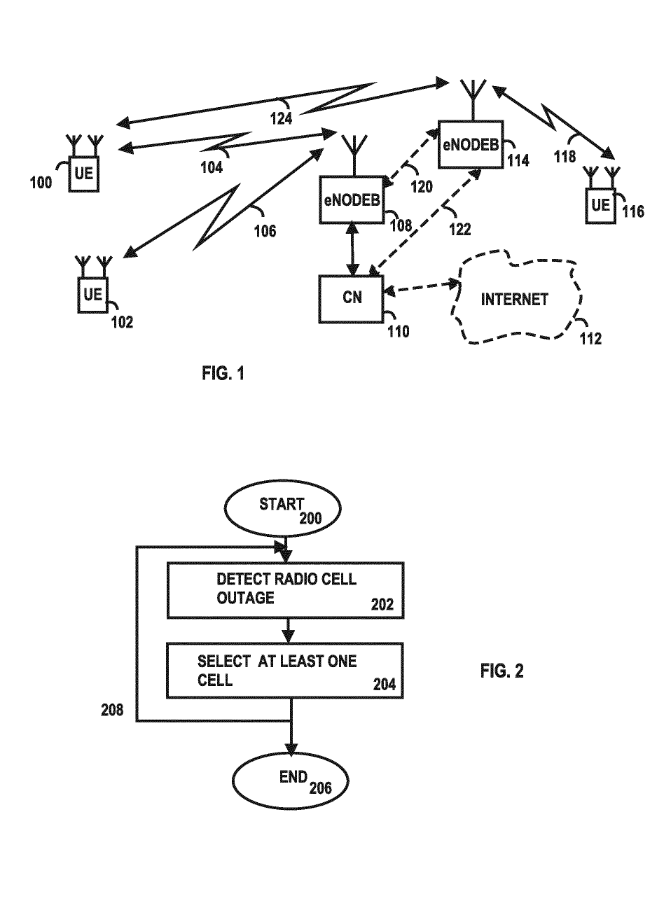

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows a part of a radio access network based on E-UTRA, LTE, or LTE-Advanced (LTE-A).

FIG. 1 shows user devices 100 and 102 configured to be in a wireless connection on one or more communication channels 104 and 106 in a cell with a (e)NodeB 108 providing the cell. The physical link from a user device to a (e)NodeB is called uplink or reverse link and the physical link from the NodeB to the user device is called downlink or forward link.

In the example of FIG. 1, another (e)Node B 114 provides another cell which resources the user device 100 may use via a wireless link 124. Also user device 116 is configured to be in a wireless connection on a communication channel 118. The (e)NodeB 114 may achieve core network resources directly via connection 122 or via the (e)NodeB 108, if the (e)NodeBs form a cluster. It should be noted that in the LTE, the wireless connections 104 and 124 are optional to each other, since user devices are usually able to use only one simultaneous radio connection.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), plug-in data modem (such as a universal serial bus, USB, stick), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1 may provide any kind of these cells. A cellular radio system may be implemented as a multilayer network including several kinds of cells and some of the cells may belong to different radio access technology layers. Typically, in multilayer networks, one node B provides one kind of a cell or cells, and thus a plurality of (e) Node Bs are required to provide such a network structure.

Recently for fulfilling the need for improving the deployment and performance of communication systems, the concept of “plug-and-play” (e)Node Bs has been introduced. Typically, a network which is able to use “plug-and-play” (e)Node (e)Bs, may include, in addition to Home (e)Node Bs (H(e)nodeBs), a home node B gateway, or HNB-GW (not shown in FIG. 1). A HNB Gateway (HNB-GW), which is typically installed within an operator's network may aggregate traffic from a large number of HNBs back to a core network. With increasing number of personal, local and wireless communication systems operating in a same geographical area, the questions of co-existence and inter-networking are raised. Cognitive and re-configurable radios may be a key for obtaining a heterogeneous communication environment where mitigation techniques and cognitive signalling are used for sharing the spectrum and routing information. Spectrum sharing or flexible spectrum usage between different layers or cells of a same radio access network (RAN), between different RANs of a same operator, (such as part of refarming), between different operators, etc., is recognized as a promising method to enhance the usage of available frequency domain resources. One of the basic sources for spectrum sharing gain is provided by large variations of traffic offered to a cell.

Cognitive radios are designed to efficient spectrum use deploying so-called smart wireless devices being capable to sense and detect the environment and adapt to it thus being suitable for opportunistic spectrum usage, in which also the frequency bands not being used by their primary (usually licensed) users may be utilized by secondary users. For this purpose cognitive radios are designed to detect unused spectrum, such as spectrum holes. Alternatively, network may store information about spectrum resources that are available for a secondary usage. The information on spectrum resources may be combined with geo-location of a device, and thus available spectrum resources for the device in this particular location may be defined.

The heterogeneous networks may also create new challenges due to the deployment of different wireless nodes such as macro/micro eNBs, pico eNBs, and Home eNBs creating a multi-layer network using the same spectrum resource.

To meet high data throughputs, support of wider transmission bandwidths is usually required. One option is to provide carrier aggregation. In carrier aggregation, multiple component carriers are aggregated on the physical layer to provide the required bandwidth. Additionally, in carrier aggregation, data to be transmitted may be divided among node apparatuses involved in data transmission. This “data split” may be carried out in many different network elements. One option is a base station or node apparatus having control over transmitting nodes. This provides a close control point for downlink transmission in each radio access link from the network point of view.

The next generation mobile networks (NGMN) alliance and 3rd generation partnership project (3GPP) have standardized a set of capabilities known as self-organizing networks (SON). SON is targeted to simplify operation and maintenance of networks and thus decrease operational expenses (OPEX) by reducing pre-planning of network configurations. SON provides self-configuring of networks for “plug-and-play” devices and also some self-operating and self-optimisation features, such as multivendor tracing, quality-of-services optimisation and interference control.

In the following, some embodiments are disclosed in further details in relation to FIG. 2. Embodiments are suitable for managing a cell outage in a wireless network. The outage of a cell refers to the situation wherein, at least practically speaking, no services can be provided via this cell to end users. An unplanned cell outage may take place quite frequently in a network due to various reasons: power outage, hardware failure, software fault, missing backhaul transmission link, equipment theft, etc.

Typical problems related to the cell outage are the detection of such a cell state and at least partial compensation of it. The detection may be carried out relatively easy: either by using dedicated hardware (HW) alarms to indicate that the cell is not in an operational state, by an explicit notification coming from another network element (such as a device detecting loss of a previously known neighbour cell), or by functionality that detects the problem, such as performance measurements key performance indicator (e.g. PM KPI monitoring in the LTE). The at least partial compensation may be understood as the ability of the network as a whole to provide at least partial signal coverage and service capacity to the areas previously served by the now unavailable cell. An option is to change the configuration of surrounding or neighbour cells in such a manner that the coverage of the surrounding or neighbour cells is (temporarily) increased to cover at least partially the serving area of the outage cell. Coverage improvement may be achieved by changing the tilts of antennas for the cells and/or by changing transmission power of the cells.

However, according to the experience based on studying real network data, it can be stated that in many cases tilts are set to low values or even to zero degrees in order not to limit the coverage of the cell. Further, it is not possible to change a tilt remotely, if remote electrical tilting (RET) functionality is not provided. Moreover, a remote electrical tilt change affects only the electrical part of the tilt. A mechanical tilt cannot be changed remotely. Additionally, in the case an antenna is down-tilted by several degrees up-tilting of such an antenna for cell outage compensation may cause a coverage hole near the location of the antenna. Thus, the cell outage problem may even be spread. This possibility would do well to take into consideration especially for antennas located on high buildings, towers etc.

On the other hand, the possible increase of transmission power is usually limited by available power resources. Usually, a node operates at its highest power to fully utilize its capability; unless important reasons to decrease its power due to planning/optimization constraints exist. Hence, in most cases transmission power may not be increased at all or at least not enough to compensate a cell outage.

One embodiment may be carried out by a device configured to operate as a network element, node, host, server or user device.

The embodiment starts in block 200 of FIG. 2.

In block 202, a radio cell outage is detected.

The detection may be carried out by a plurality of ways. Some examples are using one or more dedicated hardware (HW) alarms to indicate that the cell is not in an operational state, by an explicit notification coming from another network element (such as a device detecting loss of a previously known neighbour cell) or by functionality that detects the problem, usually one or more performance indicators, such as a performance measurements key performance indicator (PM KPI monitoring in the LTE).

In block 204, at least one radio cell is selected for at least partial compensation of the radio cell outage.

The selected one or more radio cells are typically surrounding or neighbouring cells of a cell attacked by cell outage. The number of cells may vary according to the amount of compensation needed. One criterion for the selection may be that the operation of as few cells as possible are interfered with these additional service requests. However, the target usually is full service compensation, if possible to achieve. On the other hand, the selected cells should be able to maintain satisfactory level of operation.

It should be appreciated that services may be transferred also by using a forced handover between cells.

In one embodiment, a service adaptation message is conveyed for obtaining at least partial compensation of a radio cell outage.

The service adaptation message may be a dedicated message, part of another message or a side-operation achieved by another message or some other suitable activity. One target is to inform selected nodes that they will take part in cell outage compensation. Another target is to temporally suspend the service provided to user devices in any of the cells participating in the cell outage compensation. During the suspension time one or more cells that compensate a cell outage may reconfigure itself or themselves to operate in a lower channel bandwidth. One option for such a message is to introduce a new field in a radio resource control (RRC) connection reconfiguration message in the MobilityControlInfo IE. The field may be: dl-Bandwidth-Compensation-State. It should be appreciated that two areas relevant to message exchange usually exist. One is when a node is informed that it has to change its operating bandwidth due to an operational failure taken place in a neighbour cell. Another one is that the node has to inform its users that the operating bandwidth is going to be decreased.

The service adaptation may be decreasing a channel bandwidth (typically for transmission). It should be appreciated that the decreasing the channel bandwidth may also be combined with antenna tilting and/or transmission power adaptation described above.

The service adaptation message may be conveyed by a network reconfiguration entity, such as a server, node or host carrying out network (re)configuration tasks.

An embodiment utilises carrier aggregation scenario: one of carriers of selected one or more cells participates in the compensation process that is operates in a decreased channel bandwidth, while other one(s) continue(s) to operate in a full bandwidth and thus maintains a full carrier capacity.

The embodiment ends in block 206. The embodiment is repeatable in many ways. One example is shown by arrow 208 in FIG. 2.

Another embodiment may be carried out by a device configured to operate as a network element, node, host or server, or user device.

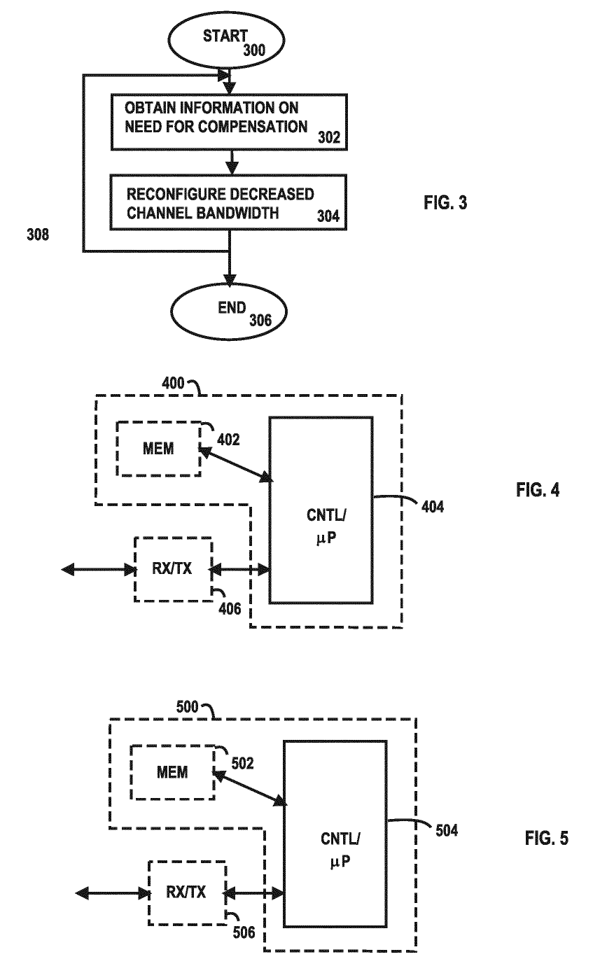

The embodiment starts in block 300 of FIG. 3.

In block 302, information on a need for at least partial compensation of a radio cell outage is obtained.

In an example, a network element has detected a radio cell outage and selected at least one cell for service compensation purposes. Then it informs the at least one cell about the need for this compensation. The information may be conveyed by a service adaptation message which may be a dedicated message, part of another message or a side-operation achieved by another message or some other suitable activity. One target is to inform selected nodes that they will take part in cell outage compensation. Another target is to temporally suspend the service provided to user devices in any of the cells participating in the cell outage compensation. During the suspension time one or more cells that compensate a cell outage may reconfigure itself or themselves to operate in a lower channel bandwidth. One option for such a message is to introduce a new field in a radio resource control (RRC) connection reconfiguration message in the MobilityControlInfo IE. The field may be: dl-Bandwidth-Compensation-State.

In block 304, a decreased channel bandwidth is reconfigured for at least temporal usage.

The adapted bandwidth may be transmission bandwidth and/or reception bandwidth.

The transmission bandwidth may be adapted in such a way that during a cell outage, the channel bandwidth of selected cells is decreased automatically and adaptively to increase the coverage of the selected cells and to compensate the coverage hole in the network.

The level of adaptation may depend on the site-to-site distance for the cells taking care of compensation and/or a clutter type. The more open the area is (rural, longer site-to-site distance), the smaller channel bandwidth is needed to compensate a coverage hole. The level of adaptation may in certain cases be limited by currently adapted operating bandwidth specifications.

The lower bandwidth may be indicated in the aforementioned dl-Bandwidth-Compensation-State field.

It should be appreciated that an option for the transferred services to be transferred back to the original serving cell via the already specified radio resource control (RRC) connection reestablishment procedure may be provided.

It should be appreciated that services may be transferred also by using a forced handover between cells.

It should further be appreciated that the embodiment may also be combined with antenna tilting and/or transmission power adaptation described above.

An embodiment utilises carrier aggregation scenario: one of carriers of selected one or more cells participates in the compensation process that is operates in a decreased channel bandwidth, while other one(s) continue(s) to operate in a full bandwidth and thus maintains a full carrier capacity.

The embodiment ends in block 306. The embodiment is repeatable in many ways. One example is shown by arrow 308 in FIG. 3.

An environment wherein embodiments of FIGS. 2 and 3 may be applied to is a self-organising network, wherein the network configures and reconfigures itself according to current needs. In such a case, apparatuses of embodiments described by means of FIG. 2 and by means of FIG. 3 may communicate together. It is understood that the number of cells participating in cell outage compensation or the number of cells suffering from operational problems may vary in a communication system in the course of time. One example of operation in a self-organising network is now explained by means of FIG. 1. Let us assume that in an exemplary case (e)NodeB 114 may be attacked by a cell outage. Then the (e)NodeB 114 detects this radio cell outage, selects at least one radio cell for at least partial compensation of the radio cell outage and conveys a service adaptation message. In this example, the selected radio cell is provided by the (e)NodeB 108 which is also informed about service need and thus a need to adapt its operation. The user device 116 and/or the user device 100 receive this information and reconfigure to adapt to a decreased (transmission) channel bandwidth typically temporally until the radio cell is recovered, and/or the (e)NodeB 108 receives the information and carries out necessary actions. Thus, both user devices and nodes may adapt their operation, if required. It should be understood that this example is presented herein only for clarification purposes and it should not be taken as limiting the applicability of embodiments.

It should also be understood that in embodiments described above in relation to FIGS. 2 and 3, a node taking part to outage compensation may be “activated” or informed by signalling carried out by a central node, by any node or it may take an autonomous decision. User devices in turn may be informed by signalling carried out by the central node or by any other node involved, or the adaptation may be carried out seamlessly without signalling.

The steps/points, signaling messages and related functions described above in FIGS. 2 and 3 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting and/or receiving may herein mean preparing a data conveyance, transmission and/or reception, preparing a message to be conveyed, transmitted and/or received, or physical transmission and/or reception itself, etc. on a case by case basis. The same principle may be applied to terms transmission and reception as well.

An embodiment provides an apparatus which may be any user device, relay node, node, host, webstick or server any other suitable apparatus capable to carry out processes described above in relation to FIG. 2.

FIG. 4 illustrates a simplified block diagram of an apparatus according to an embodiment.

As an example of an apparatus according to an embodiment, it is shown apparatus 400, including facilities in control unit 404 (including one or more processors, for example) to carry out functions of embodiments according to FIG. 2. The facilities may be software, hardware or combinations thereof as described in further detail below.

Another example of apparatus 400 may include at least one processor 404 and at least one memory 402 including a computer program code, the at least one memory and the computer program code configured to, with the at least one processor, cause the apparatus at least to: detect a radio cell outage, and select at least one radio cell for at least partial compensation of the radio cell outage.

Yet another example of an apparatus comprises means (404) for detecting a radio cell outage, and means (404) for selecting at least one radio cell for at least partial compensation of the radio cell outage.

Yet another example of an apparatus comprises a detector configured to detect a radio cell outage, and a selector configured to select at least one radio cell for at least partial compensation of the radio cell outage.

It should be understood that the apparatuses may include or be coupled to other units or modules etc., such as those used in or for transmission and/or reception. This is depicted in FIG. 4 as optional block 406. In FIG. 4, block 406 includes parts/units/modules needed for reception and transmission, usually called a radio front end, RF-parts, radio parts, radio head, etc.

Although the apparatuses have been depicted as one entity in FIG. 4, different modules and memory may be implemented in one or more physical or logical entities.

An embodiment provides an apparatus which may be any user device, relay node, node, host, webstick or server any other suitable apparatus capable to carry out processes described above in relation to FIG. 3.

FIG. 5 illustrates a simplified block diagram of an apparatus according to an embodiment.

As an example of an apparatus according to an embodiment, it is shown apparatus 500, including facilities in control unit 504 (including one or more processors, for example) to carry out functions of embodiments according to FIG. 3. The facilities may be software, hardware or combinations thereof as described in further detail below.

Another example of apparatus 500 may include at least one processor 504 and at least one memory 502 including a computer program code, the at least one memory and the computer program code configured to, with the at least one processor, cause the apparatus at least to: obtain information on a need for at least partial compensation of a radio cell outage, and reconfigure a decreased channel bandwidth for at least temporal usage.

Yet another example of an apparatus comprises means (504, (506)) for obtaining information on a need for at least partial compensation of a radio cell outage, and means (504) for reconfiguring a decreased channel bandwidth for at least temporal usage.

Yet another example of an apparatus comprises an obtainer configured to obtain information on a need for at least partial compensation of a radio cell outage, and a reconfigurator configured to reconfigure a decreased channel bandwidth for at least temporal usage.

It should be understood that the apparatuses may include or be coupled to other units or modules etc., such as those used in or for transmission and/or reception. This is depicted in FIG. 5 as optional block 506. In FIG. 5, block 506 includes parts/units/modules needed for reception and transmission, usually called a radio front end, RF-parts, radio parts, radio head, etc.

Although the apparatuses have been depicted as one entity in FIG. 5, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be at least one software application, module, or unit configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, C#, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation. Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code,
the at least one memory and the computer program code configured to, with the at least one processor, cause the apparatus at least to:
detect a radio cell outage, and
select at least one radio cell for at least partial compensation of the radio cell outage.

2. The apparatus of claim 1, further comprising causing the apparatus to:
convey a service adaptation message for the at least partial compensation of the radio cell outage.

3. The apparatus of claim 1, wherein the detection is carried out by using one or more dedicated hardware alarms and/or performance indicators.

4. The apparatus of claim 1, wherein the detection is carried out by a user device.

5. The apparatus of claim 1, wherein the detection is carried out autonomously by a node.

6. The apparatus of claim 1, wherein the service adaptation message is a radio resource control (RRC) connection reconfiguration message or a part of it.

7. The apparatus of claim 2, wherein the service adaptation message is exchanged by nodes involved.

8. The apparatus of claim 2, wherein the service adaptation message conveyed by a network reconfiguration entity.

9. The apparatus of claim 1, wherein the least partial compensation of the radio cell outage carried out by decreasing channel bandwidth.

10. The apparatus of claim 1, further comprising causing the apparatus to:
carry out antenna tilting and/or transmission power adaptation for at least partial compensation of the radio cell outage.

11. The apparatus of claim 1, further comprising causing the apparatus to:
operate part of the carriers by using a decreased channel bandwidth, when carried aggregation is used.

12. The apparatus of claim 1, the apparatus comprising a user device, server, host of node.

13. A computer program comprising program instructions which, when loaded into the apparatus, constitute the modules of claim 1.

14. An apparatus comprising:
at least one processor and at least one memory including a computer program code,
the at least one memory and the computer program code configured to, with the at least one processor, cause the apparatus at least to:
obtain information on a need for at least partial compensation of a radio cell outage, and
reconfigure a decreased channel bandwidth for at least temporal usage.

15. The apparatus of claim 14, wherein the
information is a service adaptation message implemented by a radio resource control (RRC) connection reconfiguration message or a part of it.

16. The apparatus of claim 14, wherein the information or the service adaptation message is exchanged by nodes involved.

17. The apparatus of claim 14, wherein the information or the service adaptation message conveyed by a network reconfiguration entity.

18. The apparatus claim 14, further comprising causing the apparatus to:
carry out antenna tilting and/or transmission power adaptation for at least partial compensation of the radio cell outage.

19. The apparatus of claim 14, further comprising causing the apparatus to:
operate part of the carriers by using a decreased channel bandwidth, when carried aggregation is used.

20. The apparatus of claim 14, further comprising causing the apparatus to: transferred services to be transferred back to the original serving cell via already specified radio resource control (RRC) connection reestablishment procedure.

21. The apparatus of claim 14, further comprising causing the apparatus to:
transfer services back to an original serving cell via a radio resource control (RRC) connection reestablishment procedure.

22. The apparatus of claim 14, the apparatus comprising a host, node, server or user device.

23. A computer program comprising program instructions which, when loaded into the apparatus, constitute the modules of any claim 14.

24. A method comprising:
detecting a radio cell outage, and
selecting at least one radio cell for at least partial compensation of the radio cell outage.

25. The method of claim 24, further comprising:
conveying a service adaptation message for the at least partial compensation of the radio cell outage.

26. The method of claim 24, wherein the detection is carried out by using one or more dedicated hardware alarms and/or performance indicators.

27. The method of claim 24, wherein the detection is carried out by a user device.

28. The method of claim 24, wherein the detection is carried out autonomously by a node.

29. The method of claim 24, wherein the service adaptation message is a radio resource control (RRC) connection reconfiguration message or a part of it.

30. The method of claim 25, wherein the service adaptation message is exchanged by nodes involved.

31. The method of claim 25, wherein the service adaptation message conveyed by a network reconfiguration entity.

32. The method of claim 24, wherein the at least partial compensation of the radio cell outage is carried out by decreasing channel bandwidth.

33. The method of claim 24, further comprising:
carrying out antenna tilting and/or transmission power adaptation for at least partial compensation of the radio cell outage.

34. The method of claim 24, further comprising:
operating part of the carriers by using a decreased channel bandwidth, when carried aggregation is used.

35. An apparatus comprising means for carrying out the method according to claim 24.

36. A method comprising:
obtaining information on a need for at least partial compensation of a radio cell outage, and
reconfiguring a decreased channel bandwidth for at least temporal usage.

37. The method of claim 36, wherein the information is a service adaptation message implemented by a radio resource control (RRC) connection reconfiguration message or a part of it.

38. The method of claim 36, wherein the information or the service adaptation message is exchanged by nodes involved.

39. The method of claim 36, wherein the information or the service adaptation message conveyed by a network reconfiguration entity.

40. The method claim 36, further comprising: carrying out antenna tilting and/or transmission power adaptation for at least partial compensation of the radio cell outage.

41. The method of claim 36, further comprising:
operating part of the carriers by using a decreased channel bandwidth, when carried aggregation is used.

42. The method of claim 36, further comprising:
transferring services to be transferred back to the original serving cell via already specified radio resource control (RRC) connection reestablishment procedure.

43. The method of claim 36, further comprising:
transferring services back to an original serving cell via a radio resource control (RRC) connection reestablishment procedure.

44. An apparatus comprising means for carrying out the method claim 36.

45. A computer program embodied on a computer-readable storage medium, the computer program comprising program code for controlling a process to execute a process, the process comprising:
detecting a radio cell outage, and
selecting at least one radio cell for at least partial compensation of the radio cell outage.

46. A computer program embodied on a computer-readable storage medium, the computer program comprising program code for controlling a process to execute a process, the process comprising:
obtaining information on a need for at least partial compensation of a radio cell outage, and
reconfiguring a decreased channel bandwidth for at least temporal usage
